(19) United States
(12) Patent Application Publication
(10) Pub. No.: US 2011/0169361 A1
(43) Pub. Date: Jul. 14, 2011

(54) POLYGON MOTOR

(76) Inventor: Sang Hwan PARK, Gyunggi-do (KR)

(21) Appl. No.: 12/725,335

(22) Filed: Mar. 16, 2010

(30) Foreign Application Priority Data
Jan. 12, 2010 (KR) 10-2010-0002832

(51) Int. Cl. H02K 5/24

(52) U.S. Cl. 310/91

(57) ABSTRACT

A polygon motor. The polygon motor includes a rotor casing for loading a magnetic disc or an optical disc thereon, a rotatable shaft fitted into the rotor casing and supporting the rotor casing, a bearing rotatably supporting the rotatable shaft and having a hollow cylindrical shape, a stator producing an electric field for rotating the rotor casing, and a shock absorbing member provided at a location below the bearing and relieving external shock.

### CROSS REFERENCE TO RELATED APPLICATION(S)

This application claims the benefit of Korean Patent Application No. 10-2010-0002832, filed on Jan. 12, 2010, entitled “Polygon Motor”, which is hereby incorporated by reference in its entirety into this application.

### BACKGROUND OF THE INVENTION

1. Technical Field

The present invention relates to a polygon motor.

2. Description of the Related Art

In recent years, high-capacity storage devices, such as CDs (compact disk), DVDs (digital versatile disk), BDs (blue-ray disk), HD DVDs (high definition disk), etc., have been widely used in accordance with the development of electronic instruments. Thus, it is required to provide high speed disc drives used for driving the high-capacity storage devices.

A polygon minor scanner motor (hereinbelow, referred to simply as “polygon motor”) is installed in a laser scanning unit of a laser beam printer and deflects a laser beam.

The polygon motor is provided with a polygon mirror and rotates at a high speed, and reflects a laser beam carrying printing information along the surface of the polygon mirror such that the laser beam can be scanned onto an OPC drum and printing can be executed.

To realize high speed printing, which is one of the most important merits and desired characteristics of laser printers, it is required to realize high speed rotation of the polygon motor. However, the realization of the high speed rotation of the polygon motor is undesirably accompanied by the generation of noises in the motor. The noises generated in the high speed polygon motor are attributable to friction between a high speed rotor and air. Further, when a rotor of the polygon motor is unbalanced in mass, an LSU or a printer set having the polygon motor may resonate or be excited due to the vibration of the polygon motor, thus generating noises. In the related art, a technique to reduce to an acceptable level the noise of the LSU or the printer set which has polygon motor by controlling the mass unbalance of the high speed rotor during the production process of the polygon motor has been proposed.

However, when the rotating speed of the polygon motor increases to a high level, a small mass unbalance of the rotor may easily produce noises in the polygon motor. Further, even when the mass unbalance of the rotor can be controlled to an acceptable level by balancing the rotor during the production process of the polygon motor, the mass unbalance of the rotor may be increased due to external shocks generated from careless treatment of an LSU or a printer set after the polygon motor has been installed in the LSU or the printer set. to In the above state, the polygon motor produces noise. In other words, the external shock causes the rotor of the polygon motor to move upwards and brings a rotor casing into contact with a rotor stopper, thus increasing the mass unbalance of the rotor.

Therefore, it is required to provide a technique to control the mass unbalance of the rotor, which may be increased by the contact between the rotor casing and the rotor stopper when the rotor moves upwards in response to external shock applied to the polygon motor.

### SUMMARY OF THE INVENTION

The present invention is intended to provide a polygon motor, which can control mass unbalance increased by the contact between a rotor casing and a stopper when a rotor moves upwards in response to external shock applied to the polygon motor.

In one aspect of the present invention, there is provided a polygon motor, comprising a rotor casing for loading a magnetic disc or an optical disc thereon, a rotatable shaft fitted into the rotor casing and supporting the rotor casing, a bearing rotatably supporting the rotatable shaft and having a hollow cylindrical shape, a stator producing an electric field for rotating the rotor casing, and a shock absorbing member provided at a location below the bearing and relieving external shock.

Here, a stopper may be provided at a location below a lower surface of the shock absorbing member.

Further, the shock absorbing member may be made of sponge or rubber.

Further, the shock absorbing member may be a coil spring.

Further, the shock absorbing member may be a plate spring.

Further, the bearing may be provided with a groove in an outer circumferential surface thereof for holding one end of the shock absorbing member or one end of the stopper.

Further, the stopper may be inserted into the rotatable shaft.

The polygon motor according to the present invention has the shock absorbing member, so that the polygon motor can prevent mass unbalance of the rotor caused by external shock and can relieve shock applied to the rotor.

Here, the shock absorbing member may be freely embodied in a variety of shapes, to which can be compressed or elastically deformed in response to external force, such as compressive force, regardless of the material and shape thereof.

Further, the polygon motor having the above-mentioned construction is advantageous in that it is possible to minimize the application of external shock to the polygon motor, so that the present invention can realize a reduction in the shock and noise of the polygon motor.

### BRIEF DESCRIPTION OF THE DRAWINGS

FIG. 1 is a sectional view of a polygon motor according to a first embodiment of the present invention;

FIG. 2 is an enlarged view of the polygon motor according to the first embodiment of the present invention;

FIG. 3 is an enlarged view of a polygon motor according to a second embodiment of the present invention;

FIG. 4 is an enlarged view of a polygon motor according to a third embodiment of the present invention; and

FIG. 5 is an enlarged view of a polygon motor according to a fourth embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the terms to describe most appropriately the best method he or she knows for carrying out the invention.

The above and other objects, features and advantages of the present invention will be to more clearly understood from the following detailed description taken in conjunction with the accompanying drawings. Herein, the same reference numerals are used throughout the different drawings to designate the same components. Further, when it is determined that the detailed description of the known art related to the present invention might obscure the gist of the present invention, the detailed description thereof will be omitted.

Hereinafter, the preferred embodiments of the present invention will be described in detail with reference to the accompanying drawings.

FIG. 1 through FIG. 5 show half of a polygon motor for ease of description, however, it should be understood that the polygonal motor has a symmetrical construction.

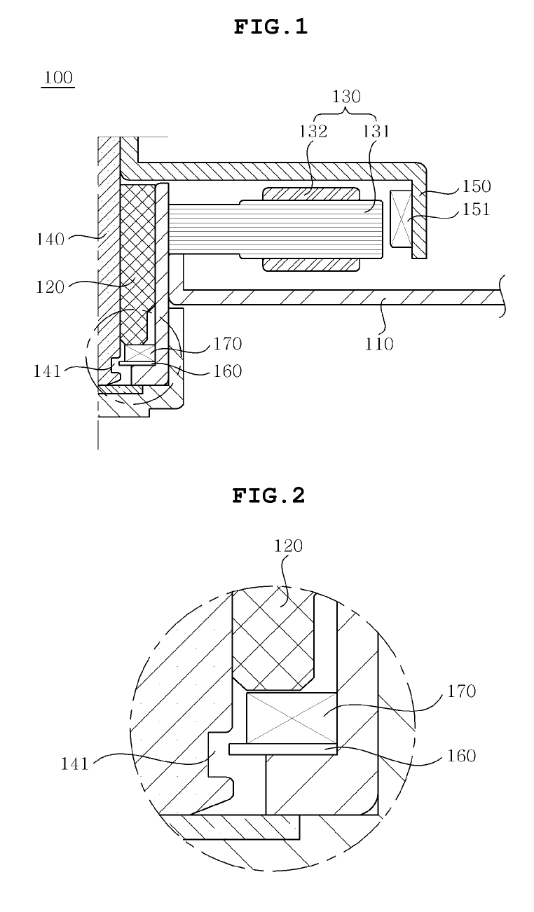

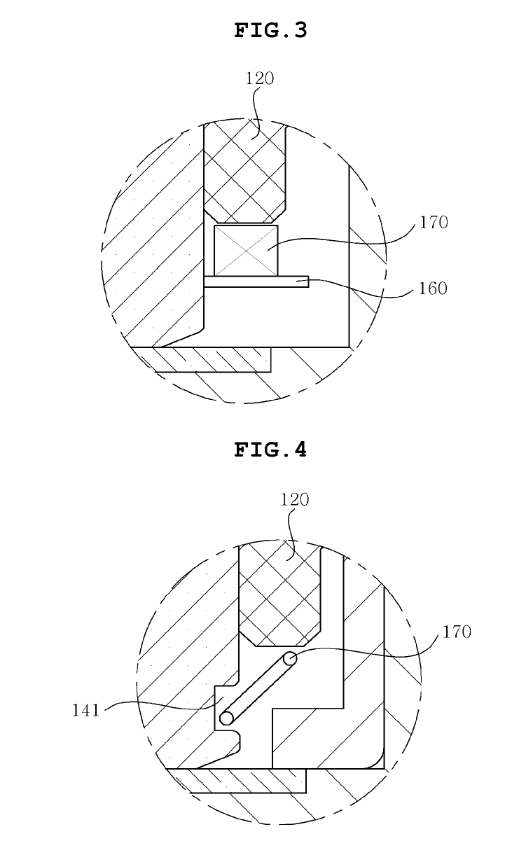

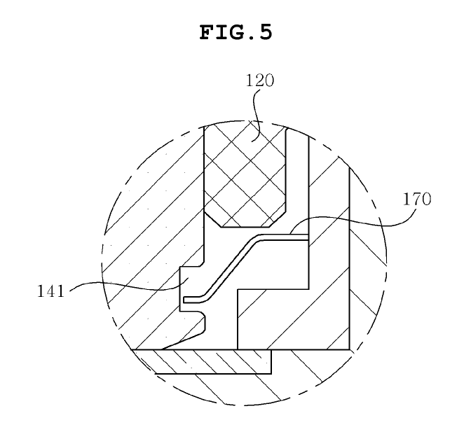

FIG. 1 is a sectional view of a polygon motor according to a first embodiment of the present invention. FIG. 2 is an enlarged view of the polygon motor according to the first embodiment of the present invention. FIG. 3 is an enlarged view of a polygon motor according to a second embodiment of the present invention. FIG. 4 is an enlarged view of a polygon motor according to a third embodiment of the present invention. FIG. 5 is an enlarged view of a polygon motor according to a fourth embodiment of the present invention. Hereinbelow, the polygon motor 100 according to the embodiments will be described with reference to the accompanying drawings.

As shown in FIG. 1, the polygon motor 100 according to the first embodiment of the present invention comprises a base plate 110, a bearing 120, a stator 130, a rotatable shaft 140, a rotor casing 150, a stopper 160 and a shock absorbing member 170.

The base plate 110 securely supports the polygon motor 100 and is securely installed in a device, such as a hard disc drive, in which the polygon motor 100 is installed. Here, the base plate 110 may be made of a light material, such as an aluminum plate or an aluminum alloy plate, or may be made of a steel plate.

The bearing 120 rotatably supports the rotatable shaft 140 and has a hollow cylindrical shape, with a fluid dynamic bearing provided in the inner circumferential surface thereof facing the rotatable shaft 140.

Here, in the outer circumferential surface of the bearing 120, a bearing holder (not shown) for supporting the base plate 110 and for supporting smooth rotation both of the bearing 120 and of the rotatable shaft 140 may be provided.

The stator 130 produces an electric field in response to electricity applied from an external power source, thus rotating the rotor casing 150 loaded with an optical disc or a magnetic disc. The stator 130 comprises a core 131, comprising thin, laminated metal plates, and a coil 132 repeatedly wound around the core 131.

The core 131 is securely installed on the outer circumferential surface of the bearing holder (not shown) and the coil 132 is wound around the core 131. Here, the coil 132 produces an electric field in response to an electric current applied from the external power source, so that an electromagnetic force is generated between the coil 132 and a rotor magnet 151 of the rotor casing 150 and the rotor casing 150 is rotated.

The rotatable shaft 140 rotatably supports the rotor casing 150 and is inserted into the bearing 120, thus being rotatably supported by the bearing 120.

On the rotor casing 150 rotates the disc and a magnetic disc or an optical disc is seated thereon. The rotor casing 150 comprises a cover part (not shown), in which the rotatable shaft 140 is securely installed, and a cylindrical part (not shown) extending from an end of the cover part (not shown).

The rotatable shaft 140 is securely inserted into the center of the cover part (not shown) and the cylindrical part (not shown) extends in an axial direction of the rotatable shaft 140 such that the inner circumferential surface of the cylindrical part faces the stator 130. The rotor magnet 151 is securely installed in the inner circumferential surface of the cylindrical part (not shown) such that the rotor magnet 151 can produce a magnetic field. Thus, an electromagnetic force can be produced between the magnetic field of the rotor magnet 151 and the electric field produced by the coil 132.

The stopper 160 is installed below the lower end of the bearing 120 and prevents the bearing 120 from vibrating vertically. In an embodiment, vertical movement of the stopper 160 may be restricted by a groove 141 formed in the rotatable shaft 140.

The shock absorbing member 170 is installed between the bearing 120 and the stopper 160. When the rotor casing 150 moves upwards along with the stopper 160, the shock absorbing member 170 provides a shock absorbing effect and continuously reduces the upward moving speed of the rotor casing 150 until the rotor casing 150 stops the upward movement. Thus, the shock absorbing member 170 sufficiently reduces the external shock to applied to the rotor casing 150 and minimizes the mass unbalance.

FIG. 2 is an enlarged view of the polygon motor according to the first embodiment of the present invention. As shown in FIG. 2, the shock absorbing member 170 is located between the bearing 140 and the stopper 160. In the embodiment, the shock absorbing member 170 may be embodied in a variety of shapes, such as a square shape or a sectorial shape, and may be made of a variety of materials, such as sponge or rubber, capable of absorbing or relieving shock.

Further, the shock absorbing member 170 may be selected from a variety of elastic elements having various shapes, such as a coil spring or a plate spring.

FIG. 3 is an enlarged view of the polygon motor according to the second embodiment of the present invention. As shown in FIG. 3, in the second embodiment, the stopper 160 is inserted into the rotatable shaft 140 and the shock absorbing member 170 is installed between the bearing 120 and the stopper 160. Here, the shock absorbing member 170 may have a variety of shapes, such as a square shape, a circular shape or a sectorial shape.

FIG. 4 is an enlarged view of the polygon motor according to the third embodiment of the present invention. As shown in FIG. 4, in the third embodiment, a groove 141 is formed in the outer circumferential surface of the rotatable shaft 140 and the shock absorbing member 170, which has a coil spring structure, is held in the groove 141 such that the shock absorbing member 170 can support the bearing 120. Here, the shock absorbing member 170, which has the coil spring structure, may be placed such that it can support the lower end of the bearing 120 and the rotor casing 150.

FIG. 5 is a partially enlarged view of a polygon motor 100 according to a fourth embodiment of the present invention. In the polygon motor 100, a groove 141 is formed in the outer circumferential surface of the rotatable shaft 140. The polygon motor 100 further includes a plate spring-shaped shock absorbing member 170 for supporting the groove 141 and the bearing 120. Here, the plate spring-shaped shock absorbing member 170 may support the lower ends both of the bearing 120 and of the rotor casing 150.

The polygon motor 100 having the above-mentioned construction includes the shock absorbing member 170, so that the polygon motor 100 can prevent the mass unbalance of the to rotor which may be the result of external shock and can release the shock which is imposed on the rotor.

Here, the shock absorbing member 170 may be freely embodied in a variety of shapes, which can be compressed or elastically deformed in response to external force, such as compressive force, regardless of the material and shape thereof.

Further, the polygon motor 100 having the above-mentioned construction is advantageous in that it is possible to minimize the application of external shock to the polygon motor 100, so that the present invention can realize a reduction in the shock and noise of the polygon motor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Accordingly, such modifications, additions and substitutions should also be understood as falling within the scope of the present invention.

What is claimed is:

1. A polygon motor, comprising:
a rotor casing for loading a magnetic disc or an optical disc thereon;
a rotatable shaft fitted into the rotor casing and supporting the rotor casing;
a bearing rotatably supporting the rotatable shaft and having a hollow cylindrical shape;
a stator producing an electric field for rotating the rotor casing; and
a shock absorbing member provided at a location below the bearing and relieving external shock.

2. The polygon motor as set forth in claim 1, further comprising:
a stopper provided at a location below a lower surface of the shock absorbing member.

3. The polygon motor as set forth in claim 1, wherein the shock absorbing member is made of sponge or rubber.

4. The polygon motor as set forth in claim 1, wherein the shock absorbing member is a coil spring.

5. The polygon motor as set forth in claim 1, wherein the shock absorbing member is a plate spring.

6. The polygon motor as set forth in claim 1, wherein the bearing is provided with a groove in an outer circumferential surface thereof for holding one end of the shock absorbing member or one end of the stopper.

7. The polygon motor as set forth in claim 2, wherein the stopper is inserted into the rotatable shaft.
